(19) United States
(12) Patent Application Publication
(10) Pub. No.: US 2026/0146507 A1
(43) Pub. Date: May 28, 2026

(54) OPEN LOOP BEAD RECOVERY SYSTEM

(71) Applicant: 1565384 ALBERTA LTD. O/A XLT ENERGY RENTALS, Grande Prairie (CA)

(72) Inventors: Mark Loos, Grande Prairie (CA); Travis Bjorklund, Grande Prairie (CA)

(21) Appl. No.: 19/397,084

(22) Filed: Nov. 21, 2025

(30) Foreign Application Priority Data
Nov. 22, 2024 (CA) 3256921

(51) Int. Cl. E21B 21/06; B01D 21/26; B01D 21/28; B01D 21/30; E21B 21/01

(52) U.S. Cl. CPC E21B 21/065; B01D 21/267; B01D 21/283; B01D 21/302; E21B 21/01

(57) ABSTRACT

An open loop drilling beads recovery system adapted for the recovery of beads from a used drilling fluid including a liquid, large solid particulates, small solid particulates and drilling beads. The system includes a fluid inlet in fluid communication with a first shale shaker unit and a second shale shaker unit, each of which are placed in parallel and include: at least one screen adapted for separation of the large solid particulate material present in the used drilling fluid to yield a once-treated drilling fluid; a bead catch tank; a manifold hydrocyclone system; and a fluid outlet in fluid communication with the manifold hydrocyclone system. In operation, the used drilling fluid enters the system through the fluid inlet and is split into a first stream and a second stream, with the first stream directed to the first shale shaker unit and the second stream directed to the second shale shaker unit. Each of the first and second shale shaker units yield once-treated drilling fluid which enters the bead catch tank of respective shale shaker units. The once-treated drilling fluid present in the bead catch tank of the first shale shaker unit is pumped to a first manifold hydrocyclone system where the small solid particulates are separated from the once-treated drilling fluid using centrifugal force created by the first manifold hydrocyclone system, thereby resulting in a first fluid/bead mixture substantially free of small solid particulates. The first fluid/bead mixture exits the first manifold hydrocyclone system and is directed to a second manifold hydrocyclone system where it is combined with a portion of the once-treated fluid present in the bead catch tank of the second shale shaker system, and the resulting combined fluid undergoes a separation step which yields a resulting second beads/fluid mixture that exits from the second manifold hydrocyclone system and is sent to the circulation system to be mixed with drilling fluid prior to being re-injected into the wellbore.

### CROSS REFERENCE TO RELATED APPLICATIONS

The present application claims priority to Canadian Patent Application No. 3,256,921 filed Nov. 22, 2024, the contents of which are incorporated herein in their entirety.

### FIELD OF THE INVENTION

The present invention relates to a bead recovery system used in drilling and excavation applications. More specifically, the invention relates to an open loop bead recovery system for use in oil and gas drilling operations.

### BACKGROUND OF THE INVENTION

In the oil and gas industry, drilling mud is used to control subsurface pressures, lubricate the drill bit, stabilize the well bore, and carry the cuttings to the surface, among other functions. Mud is pumped from the surface through the hollow drill string, exits through nozzles in the drill bit, and returns to the surface through the annular space between the drill string and the walls of the hole.

As the drill bit grinds rocks into drill cuttings, these cuttings become entrained in the mud flow and are carried to the surface. In order to return the mud to the recirculating mud system and to make the solids easier to handle, the solids must be separated from the mud. The first step in separating the cuttings from the mud involves circulating the mixture of mud and cuttings over vibrating screens called shale shakers.

The liquid mud passes through the screens and is recirculated back to the mud tanks from which mud is withdrawn for pumping downhole. The drill cuttings remain on top of the shale shaker screens; the vibratory action of the shakers moves the cuttings down the screen and off the end of the shakers to a point where they can be collected and stored in a tank or pit for further treatment or management.

U.S. Pat. No. 4,116,288 discloses a method and apparatus for processing drilling mud wherein mud containing lost circulating material is passed from the well to a separator device where it is separated from the drilling mud and is reintroduced into the drilling mud after the mud has been cleaned of undesirable solid particulate. In the separator, the lost circulating material is retained on a coarse screen while the mud and drilling solids pass to a finer mesh screen. The finer mesh screen removes the drilling solids and allows the mud to pass to the mud tank. The separator includes a structure to recirculate the lost circulating material to the mud tank.

U.S. Pat. No. 5,996,484 entitled “Drilling fluid recovery defluidization system a press process and structure” discloses a process for defluidizing earth drill cuttings, thereby extracting valuable drilling additives and returning them to the drilling-7stem while producing a dense, drier material which may be chemically treated for distillation and/or better dissolution into the environment, thereby reducing, cost in transportation and environmental treatment chemicals thus reducing environmental contamination.

U.S. Pat. No. 6,607,659 entitled “Drilling mud reclamation system with mass flow sensors”

discloses a drilling mud clarification or reclamation system. High gravity and low gravity solids are removed from the drilling mud in respective centrifugal separator stages. A plurality of in-line mass flow sensors are provided to provide real-time indication of the effectiveness of the clarification of the drilling mud, and to provide control signals to a central control station. The heavier weight components are separated from the mud and returned to the system for further use. The lighter weight components are removed and are discarded to clean the mud. A cuttings dryer is provided to remove oil from cuttings which have been separated from a shale shaker stage. A de-sludging centrifuge is also provided to remove very fine cuttings which may have a harmful effect on the viscosity of the mud.

U.S. Pat. No. 6,892,887 B2 entitled “Polymer drilling bead recovery system and related methods” discloses a polymer bead recovery apparatus comprising: a housing comprising a recovery tank having an internal cavity and an exterior surface, the recovery tank having at least one inlet and at least one outlet, the recovery apparatus having a least one circulation system for creating a force within the internal cavity of the recovery tank, the housing further comprising a walkway situated on the exterior surface of said recovery tank, the recovery tank comprising a shaker deck having a plurality of interchangeable screens and the walkway providing access to said screens, and wherein a mixture of solid particulate material, drilling fluids, polymer beads and drilled solids are separated by a first screen of the shaker deck and the remaining mixture of small materials, fluids and beads enters the recovery tank and are separated by the force created by the circulation system, the undesired small particulate materials are removed from the recovery tank and then separated and isolated by a second screen of the shaker deck and then the polymer beads are isolated, recovered and collected.

U.S. Pat. No. 7,438,142 B2 entitled “Recovery system” discloses a process for the recovery of industrial carbon material from a mixture. The mixture may include drilling fluids, drilled solids, and industrial carbon from a mud system. The process may include: separating at least a portion of the drilled solids from the mixture to form a first effluent and a drilled solids fraction; separating at least a portion of the industrial carbon from the first effluent to form a second effluent and a recovered industrial carbon fraction; and recycling at least a portion of the recovered industrial carbon to the mud system.

US Reissued Patent No. RE38367 entitled “Recovery apparatus for drilling and excavation application and related methods” discloses a recovering system includes at least one shale shaker having at least one screen and a hydrocyclone manifold system; a recovery tank having a cavity and a base, the tank having at least one inlet and at least one outlet, the recovery tank having at least one agitation system for creating force within the cavity of the recovery tank; and at least one recovery shaker having at least one screen.

Despite the systems disclosed in the prior art, there still exist a need for a system to recover beads used in drilling fluids through the use of an efficient process which minimizes spills and/or leaks as well as provides a more robust process for cleaning the beads. Further, and also desirable is a process which minimizes the time to set-up a bead recovery system on a well site.

### SUMMARY OF THE INVENTION

The present invention provides a system which overcomes a number of the drawbacks enumerated above. According to an aspect of the present invention, there is provided an open loop drilling beads recovery system, adapted for the recovery of beads from a used drilling fluid comprising: a liquid; large solid particulates; small solid particulates; and drilling beads, said system comprising:
a fluid inlet in fluid communication with a first shale shaker unit and a second shale shaker unit, each one of said first and second shale shakers units are placed in parallel and comprise:
   at least one screen adapted for the separation of said large solid particulate material present in said used drilling fluid to yield a once-treated drilling fluid;
   a bead catch tank;
   a manifold hydrocyclone system;
   a fluid outlet in fluid communication with said manifold hydrocyclone system;

where, in operation, said used drilling fluid enters the system through said fluid inlet and is split into a first stream and a second stream, wherein said first stream is directed to said first shale shaker unit and said second stream is directed to said second shale shaker unit;

where, each one of said first and second shale shaker units yielding said once-treated drilling fluid which enters said bead catch tank of respective shale shaker units;
said once-treated drilling fluid present in said bead catch tank of said first shale shaker unit is pumped to a first manifold hydrocyclone system where said small solid particulates are separated from the once-treated drilling fluid using the centrifugal force created by said first manifold hydrocyclone system resulting in a first fluid/bead mixture substantially free of small solid particulates; and
said first fluid/bead mixture exits said first manifold hydrocyclone system and is directed to a second manifold hydrocyclone system where it is combined with a portion of said once-treated fluid present in said bead catch tank of said second shale shaker system and the resulting combined fluid undergoes a separation step;
the separation step yields a resulting second beads/fluid mixture which exits from said second manifold hydrocyclone system and is sent to the circulation system to be mixed with drilling fluid prior to being re-injected into the wellbore.

According to a preferred embodiment of the present invention, the open loop drilling beads recovery system further comprises a third shale shaker placed in parallel with said second shale shakers unit, said third shale shaker comprising:
at least one screen adapted for the separation of said large solid particulate material present in said used drilling fluid to yield a once-treated drilling fluid;
a bead catch tank;
a third manifold hydrocyclone system in fluid communication with said second manifold hydrocyclone system;
a fluid outlet in fluid communication with said third manifold hydrocyclone system;

where, in operation, said used drilling fluid enters the system through said fluid inlet and is split into said first stream, said second stream and a third stream, wherein said third stream is directed to said third shale shaker unit;

where, said third shale shaker unit yielding a third once-treated drilling fluid associated with said third shale shaker unit, said third once-treated drilling fluid enters said bead catch tank of said third shale shaker unit;
said third once-treated drilling fluid present in said bead catch tank of said third shale shaker unit is pumped to a third manifold hydrocyclone system where said small solid particulates are separated from said third once-treated drilling fluid using the centrifugal force created by said third manifold hydrocyclone system resulting in a third fluid/bead mixture substantially free of small solid particulates; and
said resulting second beads/fluid mixture which exits from said second manifold hydrocyclone system is directed to said third manifold hydrocyclone system where it is combined with a portion of said third once-treated drilling fluid present in said third bead catch tank of said third shale shaker system and yields a second combined fluid which undergoes a separation step to yield a resulting third beads/fluid mixture which is sent to the circulation system to be mixed with drilling fluid prior to being re-injected into the wellbore.

Preferably, said manifold hydrocyclone system present in said first shale shaker unit comprises a first and a second hydrocyclone placed in series where the first hydrocylone comprises a fluid outlet in fluid communication with a fluid inlet of said second hydrocyclone, and wherein said second hydrocyclone comprises a fluid outlet in fluid communication with a fluid inlet of said second manifold hydrocyclone system.

According to another aspect of the present invention, there is provided an open loop drilling beads recovery system, adapted for the recovery of beads from a used drilling fluid comprising: a liquid; large solid particulates; small solid particulates; and drilling beads, said system comprising:
a fluid inlet in fluid communication with a first shale shaker unit and a second shale shaker unit, each one of said first and second shale shakers units are placed in parallel and comprise at least one screen adapted for the separation of said large solid particulate material present in said used drilling fluid to yield a once-treated drilling fluid;
a bead catch tank;
at least two manifold hydrocyclone systems, each one of said manifold hydrocyclone systems comprising a fluid outlet in fluid communication with said manifold hydrocyclone system;

where, in operation, said used drilling fluid enters the system through said fluid inlet and is split into a first stream and a second stream, wherein said first stream is directed to said first shale shaker unit and said second stream is directed to said second shale shaker unit;

where, each one of said first and second shale shaker units yielding said once-treated drilling fluid which enters said bead catch tank of respective shale shaker units;
said once-treated drilling fluid present in said bead catch tank of said first shale shaker unit is pumped to a first one of said manifold hydrocyclone system where said small solid particulates are separated from the once-treated drilling fluid using the centrifugal force created by said hydrocyclone system resulting in a first fluid/bead mixture substantially free of small solid particulates; and
said first fluid/bead mixture exits said manifold hydrocyclone system and is directed to a second one of said second manifold hydrocyclone system where remaining small solid particulates are separated from the first fluid/bead mixture using the centrifugal force created by said hydrocyclone system resulting in a second fluid/bead mixture substantially free of small solid particulates; and
said second fluid/bead mixture exits from said second manifold hydrocyclone system and is sent to the circulation system to be mixed with drilling fluid prior to being re-injected into the wellbore.

According to yet another aspect of the present invention, there is provided an open loop drilling beads recovery system, adapted for the recovery of beads from a used drilling fluid comprising: a liquid; large solid particulates; small solid particulates; and drilling beads, said system consisting of:
a fluid inlet in fluid communication with a first shale shaker unit, a second shale shaker and a third shale shaker unit, each one of said first, second and third shale shakers units are placed in parallel and comprise at least one screen adapted for the separation of said large solid particulate material present in said used drilling fluid to yield a once-treated drilling fluid;
a bead catch tank;
at least three manifold hydrocyclone systems, each one of said manifold hydrocyclone systems comprising a fluid outlet in fluid communication with said manifold hydrocyclone system;
   wherein said three shale shakers are operatively connected to one another in sequence and operate to clean drilling beads in a manner as described herein.

According to a preferred embodiment, the open loop drilling beads recovery system further comprises a trough in fluid communication with the fluid inlet and said shale shaker and interposed therebetween.

According to a preferred embodiment, the open loop drilling beads recovery system further comprises a fluid flow control valve to maintain the flow of said first and second pumps equivalent.

According to another aspect of the present invention, there is provided a method of cleaning used bead-containing drilling fluid obtained from drilling operations, said method comprising the steps of:
collecting a used bead-containing drilling fluid from a well;
passing said used bead-containing drilling fluid through a shale shaker to separate solid particulate materials from the bead-containing fluid;
passing the separated fluid through a manifold hydrocyclone system to separate fine particles from the bead-containing fluid;
disposing of the fine particles;
reintroducing the cleaned bead-containing fluid through a second manifold hydrocyclone system; and
reintroducing the twice cleaned beads directly into the well rig mud tank.

According to a preferred embodiment, said method further comprises the steps of:
sending the twice cleaned bead-containing fluid through a third manifold hydrocyclone system; and
sending the thrice cleaned beads directly into the well rig mud tank.

According to another aspect of the present invention, there is provided a method of cleaning used bead-containing drilling fluid obtained from drilling operations, said method comprising the steps of:
providing an open loop drilling beads recovery system according to the above;
collecting a used bead-containing drilling fluid from a well;
splitting said used bead containing drilling fluid into a first and a second stream of said used bead-containing fluid;
passing said first stream of said used bead-containing drilling fluid through said first shale shaker to separate solid particulate materials from the bead-containing fluid;
passing said second stream of said used bead-containing drilling fluid through said second shale shaker to separate solid particulate materials from the bead-containing fluid;
passing the separated fluid from said first shale shake through said a first one of manifold hydrocyclone system to separate fine particles from the first stream of bead-containing fluid;
disposing of the fine particles;
sending the cleaned bead-containing fluid through a second manifold hydrocyclone system while mixing with the separated fluid from said second shale shake to separate fine particles from the combined stream of bead-containing fluid to yield a twice-cleaned bead-containing fluid;
disposing of the fines particles exiting said second manifold hydrocyclone system; and
sending the twice cleaned beads directly into the well rig mud tank.

Preferably, the method further comprises the steps of:
providing a third shale shaker in parallel with said first and second shale shaker;
splitting said used bead-containing drilling fluid into a first, a second stream and a third stream of said used bead-containing fluid;
passing said third stream of said used bead-containing drilling fluid through said third shale shaker to separate solid particulate materials from the third stream of bead-containing fluid to yield a third stream of separated fluid and beads;
sending the twice cleaned bead-containing fluid through a third manifold hydrocyclone system while mixing with said third stream of separated fluid and beads from said third shale shake to separate fine particles from a second combined stream to yield a thrice-cleaned beads;
disposing of the fines particles exiting said a third one of manifold hydrocyclone system; and
sending said thrice-cleaned beads directly into the well rig mud tank.

According to a preferred embodiment, said fluid from the well rig mud tank is pumped into the bead catch tank.

According to a preferred embodiment, said fluid pumped into the bead catch tank from the well rig mud tank is pumped at the same flow rate as that of the fluid that is pumped to the manifold hydrocyclone system.

According to a preferred embodiment, the open loop drilling beads recovery system further comprises a trough in fluid communication with the fluid inlet and said shale shaker and interposed therebetween.

Preferably, there is fluid from the well rig mud tank being pumped into the bead catch tank. Preferably as well, the fluid pumped into the bead catch tank from the well rig mud tank is pumped at the same flow rate as that of the fluid that is pumped to the manifold hydrocyclone system.

According to a preferred embodiment of the present invention, the bead recovery system takes the place of the existing rigs shale bin. The drilled particles and beads travels down the existing rig's slide into the built-in trough and directly onto the shale shaker. This preferred embodiment eliminates the need for an external trough and ABS piping system and consequently minimizes the potential for spills and leaks. The drilled particles flow directly over the rear screen on the shale shaker doing the primary separation of large particles before even entering the catch tank using a 4-12 mesh screen.

Subsequently, the first pump draws fluid from the catch tank into the hydrocyclones via a hard line pipe (lowering the risk of leakage). The hydrocyclones separate the smaller particles from the drilling fluids. The hydrocyclones discharge the fine particles onto the front three screens of the shale shaker using the 60-300 mesh screens. Subsequently, the clean fluid with the remaining recovered beads leave the hydrocyclones continue directly back into the rig's suction tank. This eliminates the need for a bead shaker and all of the related equipment including hoses, piping, and use of the rig's mud row pump. The reduction in steps and equipment drastically reduces the potential for spills, breakdowns, etc.

According to a preferred embodiment, the system will use a second pump to constantly pump fluid from the rig's mud tank to the catch tank through a mud gun system for agitation in the catch tank.

Preferably, both of the bead recovery system's pumps will be controlled via a variable speed control to allow for equal fluid movement in both directions and keeping the fluid level static. This

allows the system of this preferred embodiment to be in an open loop configuration with constant fluid movement between the bead recovery system and the rig's system.

According to a preferred embodiment of the present invention, pump flows are controlled with variable speed drives extending pump life. This minimizes leaks and spills from pump failure.

According to a preferred embodiment of the present invention, the bead recovery system is manifolded and valved in a way to eliminate any switching of hoses in the event of failure. Swapping pumps at time of failure is done simply by changing which valves are open and closed.

According to a preferred embodiment of the present invention, the bead recovery system will be completely contained in one unit hauled to site by a normal oilfield tractor. This allows for even lower operating costs by eliminating the picker.

According to a preferred embodiment of the present invention, the bead recovery system allows for a simplified rig up, where the rig up time is of approximately 30-60 minutes. This greatly reduces the response time to come online therefore, the need for prior rig ups can be substantially reduced or even eliminated.

According to a preferred embodiment of the present invention, the bead recovery system will take the position of the existing rigs shale bin, which virtually eliminates the footprint of the system.

According to a preferred embodiment of the present invention, the bead recovery system will combine all of the equipment into a single unit combined with a low shale bin, this will eliminate the need for fall restraint as the personnel operating the bead recovery system will never be more than 2 meter off the ground, and will have access to the system via a small stairway.

According to a preferred embodiment of the present invention, the bead recovery system will be utilizing smaller pumps than conventional systems and will also eliminate the use of an entire shaker unit. This translates into much lower power requirements for the present system. The system according to the present invention will be using a smaller power cord and drawing less power.

According to a preferred embodiment of the present invention, the bead recovery system can also be used as an invert dryer. This is a common practice in the oilfield by many companies. The proposed system shares similarities with standard invert dryer with the addition of the hydrocyclone manifold to deal with the beads. Therefore, when running on invert-based mud systems, the rig can use the bead recovery system according to the present invention while only needing the dryer, and call in bead personnel when needing to use beads. This can be accomplished through the use of the manifold system to isolate the hydrocyclones when not needed, and changing the screen sizes to accommodate the rig's operation.

Previous methods for recovering beads in drilling mud utilized a closed loop pump system with a second shaker to separate the beads from the fluid used in order to separately wash the beads back to the drilling rigs mud system.

According to a preferred embodiment of the present invention, there is provided an bead recovery system which uses an open loop system where drilling fluid is pumped constantly from the drilling rig's mud system into the bead recovery unit. Another pump pumps fluid from the bead recovery unit through the hydrocyclone manifold directly back to the rig mud system. These pumps are preferably controlled by a variable frequency drive (VFD) to control the exact amount of fluid being transferred to equalize the flow going each way and make the level in the bead recovery unit static. This eliminates the need for the second recovery shaker thereby making the footprint of the system much more compact than conventional units/systems. Doing so also eliminates a number of potential spill points. This, in turn, translates into fewer spillage, fewer work stoppages to clean up spills, overall cleaner sites.

In a preferred embodiment of the present invention, the unit is amalgamated into the shale bin to eliminate the need for a separate trough system to carry the drilled solids from the rig shakers to the system. This eliminates the need to do a primary separation within the recovery catch tank as the rig shakers flow directly onto the shale shaker. The elimination of a recovery shaker requires performing separate testing of the beads in order to ensure that what is being sent back to the rig mud system is acceptable for continued use. The beads going back must preferably be fully cleaned of all drilling solids. The test performed off-line is a sand concentration test done on the returning fluids to the rigs mud system rather than a visual check.

### BRIEF DESCRIPTION OF THE FIGURES

The invention may be more completely understood in consideration of the following description of various embodiments of the invention in connection with the accompanying figure, in which:

FIG. 1 is a diagram of an open loop bead recovery system according to a preferred embodiment of the present invention;

FIG. 2 is a back perspective view of an open loop drilling beads recovery system according to a preferred embodiment of the present invention showing the set-up of three shale shaker units in parallel;

FIG. 3 is a top view of the an open loop drilling beads recovery system according to a preferred embodiment of the present invention showing the set-up of three shale shaker units in parallel; and

FIG. 4 is a close-up view from the back of one of the shale shaker units side present in one of said preferred embodiment of the present invention.

### DETAILED DESCRIPTION OF PREFERRED EMBODIMENTS OF THE PRESENT INVENTION

Conventional bead recovery systems install catch troughs at the end of the rig shakers to catch all drilled particles and beads, taped together using duct tape. This creates the potential for spills and leaks.

Then, 6″ ABS pipe are installed from the troughs to the bead unit catch tank and are taped together with duct tape. Once again, this causes a potential for spills and leaks. There can also be issues with slope, also can be tripping hazard when on top of the mud tanks.

A conventional recovery system work as follows: fluid is pumped from bead unit catch tank via a pump. This pump sucks directly from the bottom of the tank over the back of the shale shaker to remove large drilled particles using a 6-10 mesh screen on the rear of the shale shaker, allowing the beads and small drilled particles to flow through the screen back into the catch tank. This is how primary separation is accomplished. As well simultaneously, it pumps fluid through the catch troughs and ABS pipe to wash all drilled particles and beads back into the bead unit catch tank. There is a potential leak at this point on 2-3″ cam lock hoses as well as possible leaks and trough overflow. A centrifugal agitator is used inside the bead unit catch tank to push the larger particles in the drilled fluid to the bottom of the bead catch tank. This ensures large particles are picked up by pump 2 and flowed over the back of the shale shaker to separate them out. The fluid is then pumped from the bead unit catch tank via a pump which suction is located above the bottom of the catch tank floor approximately 30″ (so as to keep from sucking in large particles), through the hydrocyclones which separate the finer drilled particles from the beads.

The finer drilled particles are discharged out the bottom of the cones onto the front screen of the shale shaker (generally an 84 mesh screen, but can range from a 60-300 mesh screen). The screen dries the discharged particles allowing the extra fluid to flow through and back into the catch tank, while the drilled particles travel off the end of the shale shaker into the shale bin.

The clean fluid containing the remaining beads then travels from the outlet of the hydrocyclones through a 3″ cam lock hose up to the top bead shaker. This is another area of potential leak. The fluid then flows over the back of the bead shaker over screens of 45-60 mesh to dry off the beads which separates them from the clean fluid. Meanwhile, the clean fluid flows through the screens, and are fed back by gravity to the bead unit catch tank via a 4″ cam lock hose. Once again, another area for a potential leak, as well can cause overflow on shaker catch basin if the slope on the hose is too gradual. This creates a closed loop system but also creates several potential leak areas.

The clean separated beads travel off the end of the bead shaker into a catch trough. From the catch trough there is another 6″ ABS pipe installed from it returning back to the rigs suction tank, taped together using duct tape. This is another area for potential spills and leaks. A 1½″ cam lock hose is installed running from the rigs mud row pump to the catch trough, this is another area for potential leaks. This fluid flows through the catch trough and ABS pipe washing the beads back into the rigs active system. This is another area for potential leaks. Moreover, running the system in this fashion creates a reliance on rig's pump and crew to keep it running. This setup has lead, on many occasions, to cause a system shut off which, in turn, caused the beads to overfill the catch trough and spill out onto the ground.

Certain drawbacks and potential drawbacks of conventional bead recovery systems include the following:
(a) pumps flows are controlled with valves on the outlet. This can cause backpressure to the pump, pushing out seals and drastically shortening pump life. This makes pump replacing routine, and each time a pump is swapped out there is spillage;
(b) manifold systems are not used on the pumps. Thus, when a pump fails and a spare pump is required, the outlet hose has to be quickly changed to the spare pump. This causes spillage each time;
(c) equipment is required to be hauled to the site and setup using a picker, and the same applies when moving the system to another site. This is costly and time consuming;
(d) rig up time. To rig in all equipment to bring the bead unit online takes an average of 4-8 hours.

This timeframe can be a problem when a rig needs the bead recovery system online quickly.

Thus, many times specifically trained personnel must travel to a site and rig it up prior to the use or dismantling thereof. This step can cost an operator anywhere from $1500-2500 each time.
(e) large equipment footprint. Conventional systems can require an area to spot the main bead unit beside the rig's shale bin as well as a spot to set the bead shaker stand. This can sometimes be an issue on tight locations. As well, the bead shaker stand can on some occasions, require to be set up a long distance from the main bead unit. This increases the potential for spillage, as well as increases issues with slope on the hoses travelling between them; (f) with the bead shaker on top of a stand, a ladder is required

for access by personnel to the bead shaker. This makes the use of fall restraints necessary, thereby increasing hazards to personnel.

The following examples, although not intended to be limiting, are illustrative of this invention.

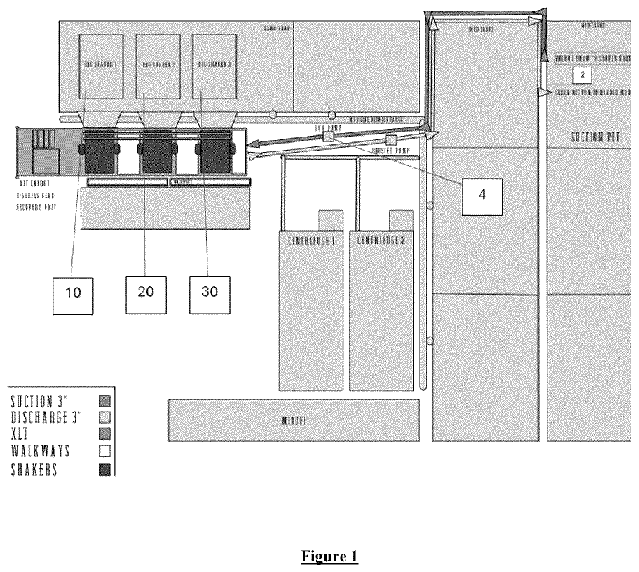

FIGS. 1 to 4 illustrate an open loop drilling beads recovery system (1) according to a preferred embodiment of the present invention. The open loop drilling beads recovery system (1) comprises a fluid inlet (10) in fluid communication with a first shale shaker (10), a second shale shaker (20) and a third shale shaker (30) having at least one screen (15, 25, 35, respectively) adapted for the separation of solid particulate material present in a drilling fluid. The drilling fluid containing various particles of varying sizes and beads travels down the existing rig's slide into the built-in trough (40) and directly onto the shale shaker (60).

According to the preferred embodiment depicted in the attached figures, each shale shaker (10, 20, 30) is, itself, in fluid communication with its respective bead catch tank (12, 22, 32) and disposes of the shale into the shale bin. In fact, each shale shaker (10, 20, 30) slopes directly into a tank. The system uses a pump (20) to constantly pump fluid from the rig's mud tank (2 in FIG. 1) to the bead catch tank (100) through a mud gun system (4 in FIG. 1) for agitation in the bead catch tank (100). This agitation prevents the various solids and particulates from settling into the tank. The partially separated drilling fluid collected in the bead catch tank (12, 22, 32) is then pumped via a second pump to their respective manifold hydrocyclone system (14, 24, 34). The partially separated drilling fluid enters the manifold hydrocyclone system (14, 24, 34) where fine particles of drilled solids are separated from the remaining fluid using the centrifugal force created by the manifold hydrocyclone system. The remaining fluid exiting said manifold hydrocyclone system go on to the subsequent hydrocyclone manifold, for example, the beads coming out of the hydrocyclone system (14) go on to hydrocyclone manifold system (24), where they are mixed in with dirty beads coming from the bead catch tank (22) to be further cleaned. The resulting beads coming from the hydrocyclone system (24) go on to hydrocyclone manifold system (34), where they are mixed in with dirty beads coming from the bead catch tank (32) to be further cleaned. The separated solids exiting each manifold hydrocyclone system (14, 24, 34) end up in the shale bin and are typically dried and discarded. This preferred approach combines enhanced effectiveness with redundancy and a robust treatment of beads. The system is adapted to clean a larger volume of beads than a single unit, but it is also capable to cleaning beads more effectively and remove more of the contaminants present on the beads, than systems with a single pass.

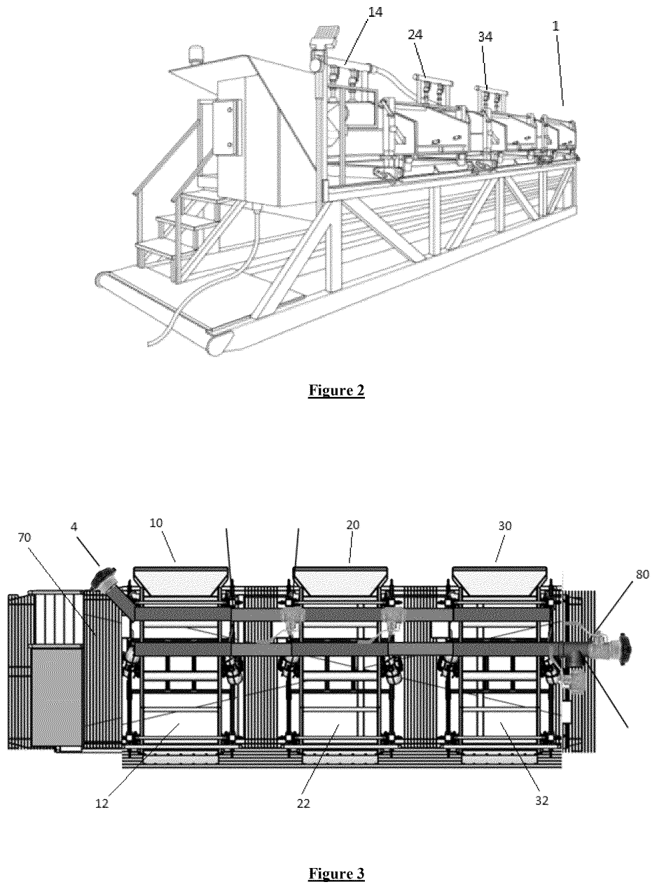

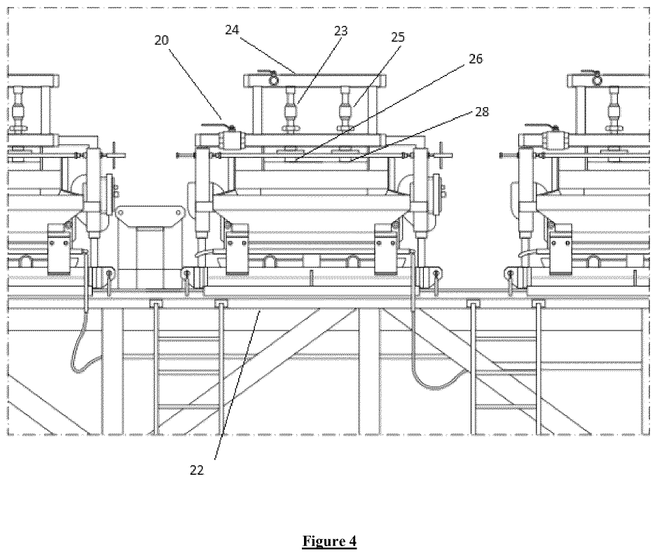

FIG. 3 shows the tubing (80) going back to the well rig tank. FIG. 2 shows the tubing (26, 28) going back from the bead catch tank (22) to the manifold hydrocyclone system (23 and 25). The system is equipped with a platform (70) on which an operator can stand to supervise the operations and inspect the screens on each shale shaker (10, 20, 30), the trough, the shale bin as well as the various tanks (12, 22, 32) and the manifold hydrocyclone system (14, 24, 34).

Preferably, the shale shaker has a series of two different mesh screens, a first screen having a screen size of 10 mesh, a second screen having a screen size from about 60 to about 300 mesh.

The process according a preferred embodiment of the present invention can be described as follows:
all drilled particles and beads travel down the existing rigs slide into a built-in trough and directly onto the shale shaker. This eliminates the need for an external trough and ABS piping system minimizing the potential for spills and leaks. This allows to skip two steps of the conventional process.

Subsequently, all drilled particles flow directly over the rear screen on the shale shaker doing the primary separation of large particles before entering the bead catch tank.

This eliminates the need for another one of the steps present in the conventional process.

A first pump draws fluid from the bead catch tank into the hydrocyclones via a hard line pipe (lowering the risk of fluid leak). The hydrocyclones separate the smaller particles and discharges the fine particles onto the three front screens of the shale shaker using standard size screens. The hydrocyclones separate the finer drilled particles from the beads. The finer drilled particles are discharged out the bottom of the cones (as the underflow) onto the three front screens of the shale shaker (generally an 84 mesh screen, but can range from a 60-300 mesh screen). The screen dries the discharged particles allowing the extra fluid to flow through and back into the bead catch tank, while the drilled particles travel off the end of the shale shaker into the shale bin for disposal.

Afterwards, the clean fluid containing the remaining beads (the overflow) leaving the hydrocyclones will continue directly back into the rig's suction tank. This eliminates the need for any additional equipment the related hoses, piping, as well as the use of the rig's mud row pump, which in turn, drastically reduces the potential for spillage. This method of processing the drilling fluid to clean the beads eliminates a number of steps the conventional process.

The process uses a second pump to constantly pump fluid from the rig's mud tank into the bead catch tank through a mud gun system for agitation in the bead catch tank. Rather than assisting in separation of the drilling solids, the mud gun system is used to stop separation and keep the drilling fluid from settling to the bottom of the bead catch tank. Both pumps are preferably controlled via a variable speed control to allow for equal fluid movement in both directions and keeping the fluid level static. This makes the system an open loop with constant fluid movement between the system and the rig's system.

The above embodiment of the present invention has at least one or more of the following advantages:
(a) pump flows are controlled with variable speed drives, thus extending pump life. This will minimize leaks and spillage from pump failure;
(b) a bead recovery system which is manifolded and valved in a way to eliminate any switching of hoses in cases of failure. Swapping pumps at time of failure is done simply by changing which valves are open and closed eliminates spillage when replacing defective or damaged pumps;
(c) the bead recovery unit is completely contained in one unit which can be hauled to a site by a normal oilfield tractor. This allows lowering the costs of mobilization and demobilization greatly by eliminating the picker;
(d) a simplified rig up time. According to a preferred embodiment of the present invention, rig up time can be done in approximately 30-60 mins. This greatly reduces the response time to come online therefore the need for prior rig ups can be substantially reduced if not completely eliminated;
(e) the bead recovery unit can take the footprint previously taken up by the existing rigs shale bin, which eliminates the necessity for any additional land space to accommodate the bead recovery unit according to a preferred embodiment of the present invention;
(f) by amalgamating the equipment into a single unit combined with a low shale bin, the need for fall restraint is virtually eliminated as the personnel should never be more than 2 meter off the ground. Whenever access points require an elevated view, the personnel can preferably access an elevated point through a small stairway;
(g) the power requirements of a bead recovery unit according to a preferred embodiment will be far less than conventional units. Smaller pumps will be used and as well as the elimination of a shaker will result in running a smaller power cord and drawing less power;
(h) the bead recovery unit according to a preferred embodiment of the present invention can also be used as an invert dryer. This is a common practice in the oilfield by many other companies.

According to a preferred embodiment of the present invention, the solids separation and bead recovery unit is very similar to the standard invert dryer with the addition of the hydrocyclone manifold to deal with the beads. Therefore, when running on invert-based mud systems, the rig can use the bead recovery unit according to a preferred embodiment of the present invention while only needing the dryer, and only call in the specialised “bead personnel” when needing to use beads. This can be accomplished by using the manifold system of a preferred embodiment to isolate the hydrocyclone manifold when not needed, and changing the screen sizes to accommodate the rig's operation.

According to a preferred embodiment of the present invention, the system further comprises an automated system comprising at least one of the following feature: radar monitoring; auto adjusting pumps; auto pump out; and fluid level monitoring.

According to a preferred embodiment of the present invention, the system comprises 3 shale Shakers over a single catch tank which can be adapted to use as fluid recovery, bead recovery, and de-silting mud system.

According to a preferred embodiment of the present invention, the system comprises 3 de-silting headers adjustable, and removable in order to provide redundancy to the system and render it more robust to overcome the need to perform a complete shutdown and suspension of operations.

According to a preferred embodiment of the present invention, the system further comprises at least one of the following: visual alarms; remote monitoring of fluid levels; pump status; shaker status; and a booster pump to achieve proper head pressure.

According to a preferred embodiment of the present invention, the system further comprises a means to overcome problems related to the hydrocyclones losing beads. Such a problem may stem from at least one of the following issues: hydrocyclones pump, hydrocyclones not at proper pressure; head pressure too high on hydrocyclones discharge; increase booster pump/block return line; apex nut needs tightening; presence of a foreign object lodged in lower cone assembly; washed hydrocyclones assembly parts hydrocyclones overwhelmed with cuttings/material; and obstructed return line, resulting in excess pressure and hydrocyclones header.

According to a preferred embodiment of the present invention, the system further comprises a means to overcome problems related to the returning dirty mud/shale to pit. Such a problem may stem from at least one of the following issues: booster pump too high or low; clogged hydrocyclones/compromised hydrocyclones; hydrocyclones pump not operating at full pressure.

According to a preferred embodiment of the present invention, the system further comprises a means to overcome problems related to the absence of volume to the units/gun pump. Such a problem may stem from at least one of the following issues: clogged/compromised feedline; clogged/compromised pump/impeller; clogged/compromised gun jets in bead tank; and obstructed/shield off point of connection at pit.

According to a preferred embodiment of the present invention, the system further comprises a means to overcome problems related to the hydrocyclone pump surging. Such a problem may stem from at least one of the following issues: overwhelming amount of cuttings/material; clogged/compromised feedline; too much booster pump RPM; clogged/compromised pump impeller; and obstructed/shaled off suction screen, and bead tank.

According to a preferred embodiment of the present invention, the system further comprises a means to overcome problems related to sporadic tank volume readings. Such a problem may stem from at least one of the following issues: dirty radar; heavy fluid disturbance in bru tank; bru tank very full of shale; and radar is compromised/run in hand.

The embodiments described herein are to be understood to be exemplary and numerous modification and variations of the present invention are possible in light of the above teachings. It is therefore to be understood that within the scope of the claims appended hereto, the invention may be practiced otherwise than as specifically disclosed herein.

1. An open loop drilling beads recovery system, adapted for the recovery of beads from a used drilling fluid comprising: a liquid; large solid particulates; small solid particulates; and drilling beads, said system comprising:
a fluid inlet in fluid communication with a first shale shaker unit and a second shale shaker unit, each one of said first and second shale shakers units are placed in parallel and comprise:
at least one screen adapted for the separation of said large solid particulate material present in said used drilling fluid to yield a once-treated drilling fluid;
a bead catch tank;
a manifold hydrocyclone system; and
a fluid outlet in fluid communication with said manifold hydrocyclone system;
where, in operation, said used drilling fluid enters the system through said fluid inlet and is split into a first stream and a second stream, wherein said first stream is directed to said first shale shaker unit and said second stream is directed to said second shale shaker unit;
where, each one of said first and second shale shaker units yielding said once-treated drilling fluid which enters said bead catch tank of respective shale shaker units;
said once-treated drilling fluid present in said bead catch tank of said first shale shaker unit is pumped to a first manifold hydrocyclone system where said small solid particulates are separated from the once-treated drilling fluid using the centrifugal force created by said first manifold hydrocyclone system resulting in a first fluid/bead mixture substantially free of small solid particulates; and
said first fluid/bead mixture exits said first manifold hydrocyclone system and is directed to a second manifold hydrocyclone system where it is combined with a portion of said once-treated fluid present in said bead catch tank of said second shale shaker system and the resulting combined fluid undergoes a separation step;
the separation step yields a resulting second beads/fluid mixture which exits from said second manifold hydrocyclone system and is sent to the circulation system to be mixed with drilling fluid prior to being re-injected into the wellbore.

2. The open loop drilling beads recovery system according to claim 1, further comprising a third shale shaker placed in parallel with said second shale shakers unit, said third shale shaker comprising:
at least one screen adapted for the separation of said large solid particulate material present in said used drilling fluid to yield a once-treated drilling fluid;
a bead catch tank;
a third manifold hydrocyclone system in fluid communication with said second manifold hydrocyclone system; and
a fluid outlet in fluid communication with said third manifold hydrocyclone system;
where, in operation, said used drilling fluid enters the system through said fluid inlet and is split into said first stream, said second stream and a third stream, wherein said third stream is directed to said third shale shaker unit;
where, said third shale shaker unit yielding a third once-treated drilling fluid associated with said third shale shaker unit, said third once-treated drilling fluid enters said bead catch tank of said third shale shaker unit;
said third once-treated drilling fluid present in said bead catch tank of said third shale shaker unit is pumped to a third manifold hydrocyclone system where said small solid particulates are separated from said third once-treated drilling fluid using the centrifugal force created by said third manifold hydrocyclone system resulting in a third fluid/bead mixture substantially free of small solid particulates; and
said resulting second beads/fluid mixture which exits from said second manifold hydrocyclone system is directed to said third manifold hydrocyclone system where it is combined with a portion of said third once-treated drilling fluid present in said third bead catch tank of said third shale shaker system and yields a second combined fluid which undergoes a separation step to yield a resulting third beads/fluid mixture which is sent to the circulation system to be mixed with drilling fluid prior to being re-injected into the wellbore.

3. The open loop drilling beads recovery system according to claim 1, wherein said manifold hydrocyclone system present in said first shale shaker unit comprises a first and a second hydrocyclone placed in series where the first hydrocyclone comprises a fluid outlet in fluid communication with a fluid inlet of said second hydrocyclone, and wherein said second hydrocyclone comprises a fluid outlet in fluid communication with a fluid inlet of said second manifold hydrocyclone system.

4. An open loop drilling beads recovery system, adapted for the recovery of beads from a used drilling fluid comprising: a liquid; large solid particulates; small solid particulates; and drilling beads, said system comprising:
a fluid inlet in fluid communication with a first shale shaker unit and a second shale shaker unit, each one of said first and second shale shakers units are placed in parallel and comprise at least one screen adapted for the separation of said large solid particulate material present in said used drilling fluid to yield a once-treated drilling fluid;
a bead catch tank; and
at least two manifold hydrocyclone systems, each one of said manifold hydrocyclone systems comprising a fluid outlet in fluid communication with said manifold hydrocyclone system;
where, in operation, said used drilling fluid enters the system through said fluid inlet and is split into a first stream and a second stream, wherein said first stream is directed to said first shale shaker unit and said second stream is directed to said second shale shaker unit;
where, each one of said first and second shale shaker units yielding said once-treated drilling fluid which enters said bead catch tank of respective shale shaker units;
said once-treated drilling fluid present in said bead catch tank of said first shale shaker unit is pumped to a first one of said manifold hydrocyclone system where said small solid particulates are separated from the once-treated drilling fluid using the centrifugal force created by said hydrocyclone system resulting in a first fluid/bead mixture substantially free of small solid particulates; and
said first fluid/bead mixture exits said manifold hydrocyclone system and is directed to a second one of said second manifold hydrocyclone system where remaining small solid particulates are separated from the first fluid/bead mixture using the centrifugal force created by said hydrocyclone system resulting in a second fluid/bead mixture substantially free of small solid particulates; and
said second fluid/bead mixture exits from said second manifold hydrocyclone system and is sent to the circulation system to be mixed with drilling fluid prior to being re-injected into the wellbore.

5. The open loop drilling beads recovery system according to claim 4, further comprising a trough in fluid communication with the fluid inlet and said shale shaker and interposed therebetween.

6. The open loop drilling beads recovery system according to claim 4, further comprising a fluid flow control valve to maintain the flow of said first and second pumps equivalent.

7. A method of cleaning used bead-containing drilling fluid obtained from drilling operations, said method comprising the steps of:
collecting a used bead-containing drilling fluid from a well;
passing said used bead-containing drilling fluid through a shale shaker to separate solid particulate materials from the bead-containing fluid;
passing the separated fluid through a manifold hydrocyclone system to separate fine particles from the bead-containing fluid;
disposing of the fine particles;
reintroducing the cleaned bead-containing fluid through a second manifold hydrocyclone system; and
reintroducing the twice cleaned beads directly into the well rig mud tank.

8. The method according to claim 7, further comprising the step of:
sending the twice cleaned bead-containing fluid through a third manifold hydrocyclone system; and
sending the thrice cleaned beads directly into the well rig mud tank.

9. The method according to claim 7, wherein fluid from the well rig mud tank is pumped into the bead catch tank.

10. The method according to claim 7, wherein the fluid pumped into the bead catch tank from the well rig mud tank is pumped at the same flow rate as that of the fluid that is pumped to the manifold hydrocyclone system.

11. A method of cleaning used bead-containing drilling fluid obtained from drilling operations, said method comprising the steps of:
providing an open loop drilling beads recovery system according to claim 1;
collecting a used bead-containing drilling fluid from a well;
splitting said used bead containing drilling fluid into a first and a second stream of said used bead-containing fluid;
passing said first stream of said used bead-containing drilling fluid through said first shale shaker to separate solid particulate materials from the bead-containing fluid;
passing said second stream of said used bead-containing drilling fluid through said second shale shaker to separate solid particulate materials from the bead-containing fluid;
passing the separated fluid from said first shale shake through said a first one of manifold hydrocyclone system to separate fine particles from the first stream of bead-containing fluid;
disposing of the fine particles;
sending the cleaned bead-containing fluid through a second manifold hydrocyclone system while mixing with the separated fluid from said second shale shake to separate fine particles from the combined stream of bead-containing fluid to yield a twice-cleaned bead-containing fluid;
disposing of the fines particles exiting said second manifold hydrocyclone system; and
sending the twice cleaned beads directly into the well rig mud tank.

12. The method according to claim 11, further comprising the steps of:
providing a third shale shaker in parallel with said first and second shale shaker;
splitting said used bead-containing drilling fluid into a first, a second stream and a third stream of said used bead-containing fluid;
passing said third stream of said used bead-containing drilling fluid through said third shale shaker to separate solid particulate materials from the third stream of bead-containing fluid to yield a third stream of separated fluid and beads;
sending the twice cleaned bead-containing fluid through a third manifold hydrocyclone system while mixing with said third stream of separated fluid and beads from said third shale shake to separate fine particles from a second combined stream to yield a thrice-cleaned beads;
disposing of the fines particles exiting said a third one of manifold hydrocyclone system; and
sending said thrice-cleaned beads directly into the well rig mud tank.
